(19) United States
(12) Patent Application Publication
(10) Pub. No.: US 2022/0163971 A1
(43) Pub. Date: May 26, 2022

(54) ROBOTIC VEHICLE WITH SAFETY MEASURES

(71) Applicant: Vektor Dynamics A/S, Sønderborg (DK)

(72) Inventor: Kenneth Skovbo Lott, Nordborg (DK)

(21) Appl. No.: 17/434,861

(22) PCT Filed: Jan. 17, 2020
(86) PCT No.: PCT/EP2020/051201

§ 371 Date: Aug. 30, 2021

(30) Foreign Application Priority Data
Jan. 28, 2019 (DK) PA201900110

(51) Int. Cl. G05D 1/02

(52) U.S. Cl. CPC G05D 1/0214; G05D 2201/0208

(57) ABSTRACT

The present invention relates to a robotic vehicle and method to operate it to move within a confined area, where the vehicle could be for mowing the lawn or for agricultural purposes having an operational part operating on an irregular surface. The control of the vehicle includes safety mechanism to check whether the vehicle seems to have left its path unintended and means to ensure the vehicle does not enter restricted areas.

### CROSS-REFERENCE TO RELATED APPLICATIONS

This application is a National Stage application of International Patent Application No. PCT/EP2020/051201, filed on Jan. 17 2020, which claims priority to Danish Application No. 201900110 filed on Jan. 28, 2019, each of which is hereby incorporated by reference in its entirety.

### TECHNICAL FIELD

The present invention relates to a robotic vehicle operated to move within a confined area, where the vehicle could be for mowing the lawn or for agricultural purposes having an operational part operating on an irregular surface. The control of the vehicle includes safety means to check whether the vehicle seems to have left its path unintended and means to ensure the vehicle does not enter restricted areas.

### BACKGROUND

When autonomously moving vehicles operate in environments where it may encounter living beings it is essential to ensure safety. This is especially relevant when the vehicle has operational means that potentially may make significant damage, such as the cutters of a lawn mower. This is even more relevant when the vehicle is of a large scale such as having dimensions comparable to a car, a small tractor or the like, with a length and width in the range of meters.

Vehicles may be controlled to follow a defined path through data received from a vehicle navigation system using a positioning system (GPS, triangulation etc.). However they would need the ability to bypass unexpected objects in the path, e.g. a chair or bicycle positioned in a field, a person etc. The diverging from the set path is one example where the vehicle potentially could get ‘lost’ or just enter otherwise restricted areas.

### SUMMARY

The object of the invention thus is to introduce an additional safety control of the vehicle.

The object is solved as indicated in the claims. This includes introducing a method to control a robotic vehicle adapted to operate in a confined area divided into subareas, said method including for the vehicle to be steered through a vehicle navigation system using a positioning system between the subareas, where measuring means are positioned on said vehicle for measuring its actual behaviour, where each subarea is associated with an expected behaviour related to confirmation that the vehicle is in the expected area according to the steering through said vehicle navigation system, and an allowed behaviour limiting an autonomous freedom of said vehicle when in said subarea.

In an embodiment the measuring means is linked to an expected subarea by the position recognition system where a comparison to the expected behaviour is made under the assumption of the expected subarea to make said confirmation, and if they do not match, then it is an indication of some fault and a safety procedure is initiated. The expected behaviour then can be linked to actual measurements to verify the actual position of the vehicle, and the allowed behaviour is set to reduce the risk of getting into restricted areas.

In an embodiment said position recognition system is independent from said positioning system. This ensures that if the one indicates wrong position, then the other may be correct. Further, due to the expected behaviour associated with each subarea, any such wrong position indication would be identified.

In an embodiment the expected behaviour includes a speed, direction and/or acceleration, and the allowed behaviour includes a range of allowed directions of said vehicle in said subarea.

In an embodiment the border subareas and inner subareas are defined such that the border subareas do not border neighbouring subareas at all sides, whereas inner subareas border neighbouring subareas at all sides, and where the allowed behaviour includes a maximum allowed speed being higher at the inner subareas than the border subareas.

In an embodiment the border subareas may be fully enclosed by other border subareas such that they can fully enclose obstacles to be excluded from the allowed confined area.

In an embodiment the maximum allowed speed of the vehicle gradually is decreased at the subareas from a highest allowed velocity inner subarea towards the border subareas.

In an embodiment the allowed directions of movement of the vehicle gradually is decreased at the subareas from a highest allowed velocity inner subarea towards the border subareas, such that any direction which would lead the vehicle towards the sides not bordering neighbouring subareas are prohibited.

In an embodiment the allowed behaviour of said vehicle relates to its autonomy in its movement to differ from the directions as set through the position recognition system.

In an embodiment said allowed behaviour is related to subareas where the signal from the positioning system (and/or the position recognition system) is known to be weak or absent, and for these subareas the allowed behaviour includes allowing full steering of the vehicle by the measurements in association with expected and allowed behaviours.

In an embodiment said allowed behaviour is related to unforeseen events affecting the movement of the vehicle and where the allowed behaviour includes departing from the route as set by the vehicle navigation system by allowing full steering of the vehicle by the measurements in association with expected and allowed behaviours for a given period.

In an embodiment the expected behaviour for each subarea is compared to the measured actual behaviour when in said subarea, and to initiate a safety procedure if they deviate from each other under some defined rule.

The solution further relates to the robotic vehicle adapted to operate in a confined area divided into subareas, where it is being steered through a vehicle navigation system using a positioning system between the subareas, where measuring means are positioned on said vehicle for measuring its actual behaviour, characterized each subarea is associated with an expected behaviour related to confirmation that the vehicle is in the expected area according to said vehicle navigation system, and an allowed behaviour limiting an autonomous freedom of said vehicle when in said subarea.

The robotic vehicle may be adapted to operate according to the method of any of the previous embodiments.

### BRIEF DESCRIPTION OF THE DRAWINGS

FIG. 1 A robotic vehicle in communication with respectively a positioning system and a position recognition system.

FIG. 2. Illustrates a confined area for the vehicle to operate, where the area is subdivided into subareas and contains stationary obstacles.

FIG. 3 Illustrates nine subareas each associated with an expected behaviour and an allowed behaviour.

FIG. 4 Edge, or border, section of the confined area neighbouring a road.

FIG. 5 A confined area showing a vehicle path along border subareas.

FIG. 6 The robotic vehicle diverging from a set path due to an unexpected obstacle.

### DETAILED DESCRIPTION

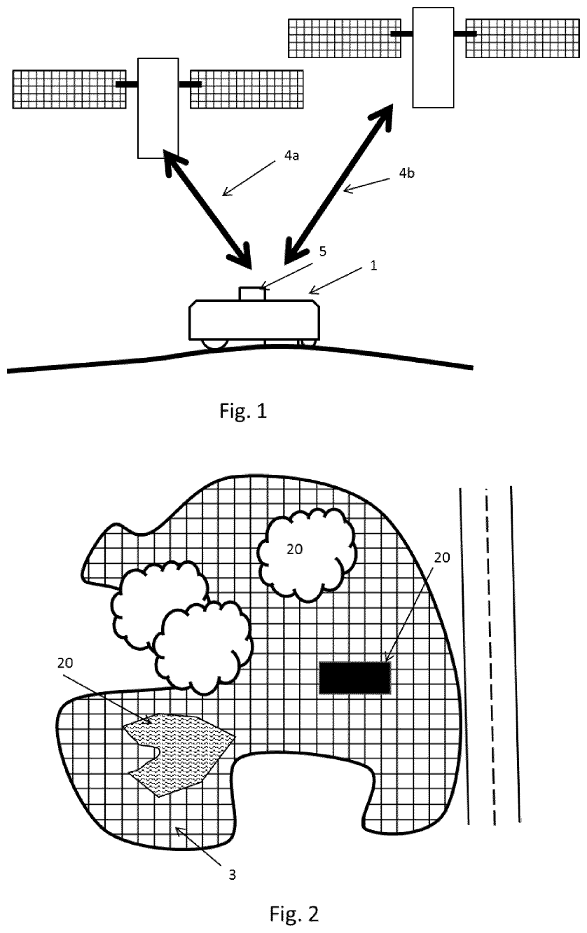

FIG. 1 illustrates a robotic vehicle (1) operated through a safety controller using a position recognition system (4a) and/or a vehicle navigation system using a positioning system (4b). Respectively the position recognition system (4a) and positioning system (4b) could be of any kind such as a satellite navigation system like GPS, GLONASS, by triangulation etc. E.g. both could be GPS systems, one could be GPS the other triangulation etc.

In one embodiment the vehicle navigation system is a separate system from the safety controller, and in another embodiment, they are integrated into the same system.

The directions, or steering, of the robotic vehicle (1) in an embodiment is done by the vehicle navigation system by position identification signals from the positioning system(4b). A safety measurement of the identification of an actual position of the vehicle is done by the position recognition system (4a). These may in one embodiment be two independently operating systems but is in other embodiments the same. A vehicle navigation system using is positioned in data exchange with the vehicle (1), or on the vehicle itself, to steer the vehicle (1) on the indicated path based on the positioning system (4b) input. This could be based on a pre-defined path set before starting, or at the start, of vehicle (1) operation, or new stretches of path could be set at intervals, either based on time or positions. In the present context, this at least partly forms the steering of the vehicle through the vehicle navigation system and positioning recognition system (4b).

The vehicle (1) however also is allowed some autonomous behaviour, where it diverges from the set path, either to re-enter it, or simply to have a new stretch of path set based on new conditions. This could be due to unforeseen obstacles to avoid.

FIG. 2 illustrate a confined area (2) where the vehicle (1) is arranged to operate. A virtual map is formed which is divided into subareas (3) each associated with an expected behaviour (7a) and an allowed behaviour (7b).

The expected behaviour (7a) is related to confirmation that the vehicle (1) is in the expected subarea (3) according to the positioning system (4b) along a set path.

The allowed behaviour (7b) is related to limiting the freedom of autonomous behaviour of said vehicle (1) when in said subarea (3), and/or related to setting a new stretch of path.

Measuring means (5) are positioned on said vehicle (1) for measuring its actual behaviour (6). The measuring means (5) could include sensors such as a gyroscope, accelerometer, speed (or velocity) sensor, wheel odometry sensors etc., and makes one or more measurements in some or all of the subareas (3) entered by the vehicle (1). As the measuring means (5) are positioned on the vehicle (1), the data represents the actual behaviour. In an embodiment the measurements from the measuring means (5) is linked to an expected subarea (3) by the position recognition system (4a). The comparison to the expected behaviour (7a) is made under the assumption of the expected subarea (3), and if they do not match, then it is an indication of some fault and the a safety procedure is initiated.

The sizes and shapes of the subareas (3) may differ. In one embodiment they are formed by a virtual grid positioned on the virtual map. They may extend over a smaller or larger area than that of the vehicle (1), and in either situation the identification of the present subarea (3) of the vehicle (1) may be related to a specific position on the vehicle (1), such as the position of the measuring means (5) and/or vehicle navigation system and/or safety controller and/or receiver of signals like the position recognition system (4a).

The safety controller operates through input from the position recognition system (4a) giving an expected position and based on this and the associated expected behaviour 7a compares to the measurements from the measuring means (5) to indicate if the vehicle (1) is in the expected subarea (3).

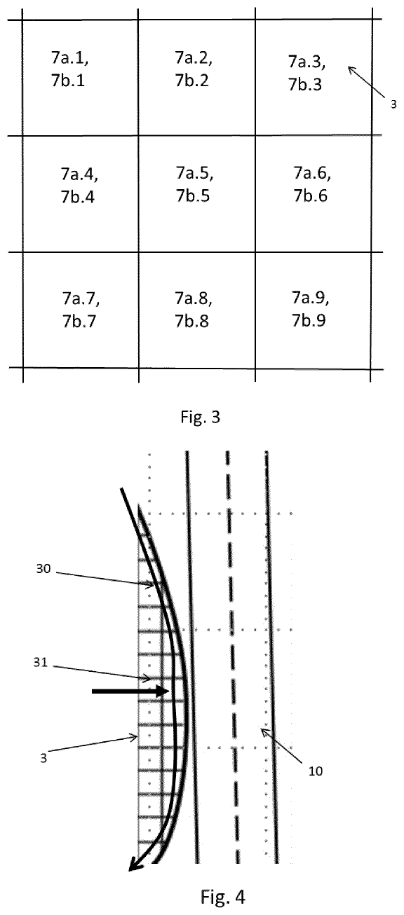

FIG. 3 illustrates nine subareas (3) each associated with an expected behaviour (7a.x), and allowed behaviour (7b.x) (‘x’ being 1-9 on the figure).

For each or some of the subareas (3) the safety controller then compares the measured actual behaviour (6) of said subarea (3) to the associated expected behaviour (6), such as speed, direction and/or acceleration etc. If they differ, then this is an indication the vehicle (1) is not actually at the expected position (in the expected subarea (3)) according to the otherwise expected set path. Therefore, a safety procedure is initiated, which could be simply to stop the vehicle (1), possible giving an indication of the error and the stop.

In addition, the safety controller checks the vehicle (1) behaviour in comparison to the allowed behaviour (7b) in an actual subarea (3), where this could include a range of allowed directions and/or speeds of said vehicle (1) in said subarea (3). It could also include combinations thereof, such as the allowed speed depending on the direction of the movement. This is illustrated in FIG. 4, where edge portion of the confined area (2) is shown edging up to e.g. a road (10) etc. It is crucial the vehicle (1) does not leave the confined area (2) to enter the road (10), which potentially is dangerous. If the vehicle (10) moves parallel (30) to the edge of the confined area (2) there is a lower risk of sudden movement onto the road (10), and the allowed behaviour (7b) therefore could include there being no restrictions to the vehicle speed, or that it is allowed to move at a relatively high speed seen in relation to the allowed speeds in general. In the situation where it moves perpendicular to, or just (31) towards the edge, and thus the road (10), then if continuing accordingly, it will enter the road (10). Therefore, in this situation the allowed behaviour for the same subareas (3) could be allowing a significantly lower speed.

In this embodiment the allowed speed thus would be conditioned by the angle of movement relative to the edge. It could in addition (or alternatively) depend on the distance to the edge, such that the allowed speed from a given distance to the edge gradually is reduced.

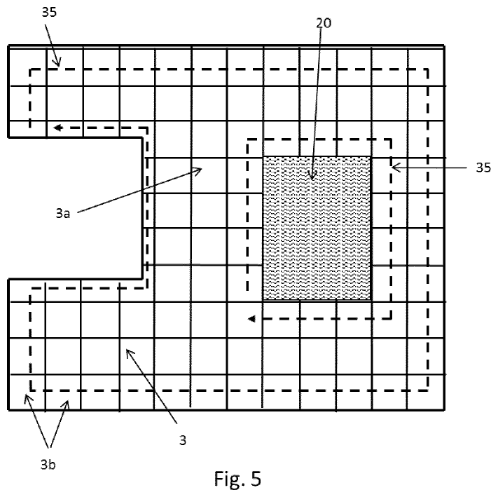

In an embodiment border subareas (3a) and inner subareas (3b) are defined such that the border subareas (3b) do not border neighbouring subareas (3) at all sides, whereas inner subareas (3a) borders neighbouring subareas (3) at all sides, and where the allowed behaviour (7b) includes a maximum allowed speed being higher at the inner subareas (3a) than the border subareas (3b). This is e.g. illustrated in FIG. 5, where in one embodiment they are defined, or identified, in an initialization procedure where the vehicle (1) is run (35a, 35b) along the borders of the allowed confined area (2). The passed subareas (3) then are setup, or identified, as border areas (3b), just as it which of the subareas (3b) are neighboured by other subareas (3b). This is done (35a) along the outer border, but also (35b) around the border of any inner known stationary obstacles (20). The vehicle (1) is then allowed to move therebetween. Such stationary obstacles (20) could include buildings, trees, plants, lakes or other prohibited areas for the vehicle (1).

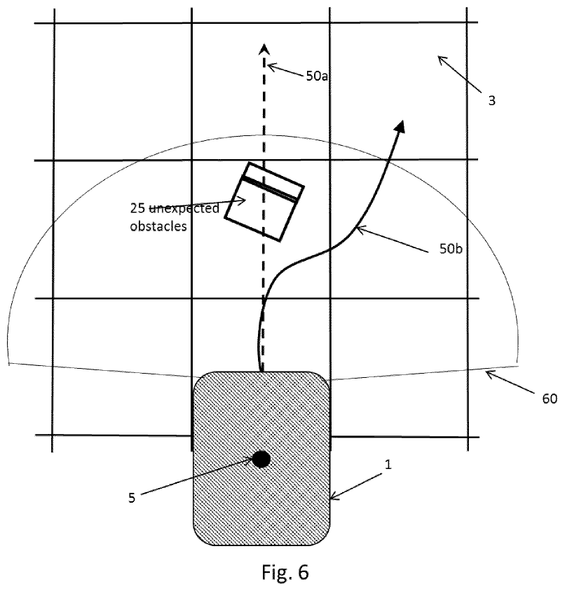

FIG. 6 illustrates another aspect where a sensor (60) detects an unexpected object (25) in the set path (50a). By the autonomy the vehicle navigation system then diverges the vehicle (1) along a new path (50b) under the allowed behaviour (7b) of the correspondingly subareas (3b). A new path may now be set (possible being the new path (50b), or the vehicle (1) is corrected back to the set path (50a).

What is claimed is:

1. A method to control a robotic vehicle adapted to operate in a confined area divided into subareas, said method including for the vehicle to be steered between the subareas, by a vehicle navigation system using a positioning system, where measuring means is positioned on said vehicle for measuring its actual behaviour, wherein each subarea is associated with an expected behaviour related to confirmation that the vehicle is in the expected area according to the steering of the between the subareas, and an allowed behaviour limiting an autonomous freedom of said vehicle when in said subarea.

2. The method to control a robotic vehicle according to claim 1, wherein the measuring means is linked to an expected subarea by the position recognition system where a comparison to the expected behaviour is made under the assumption of the expected subarea to make said confirmation, and if they do not match, then it is an indication of some fault and the safety procedure is initiated.

3. The method to control a robotic vehicle according to claim 2, wherein said position recognition system is independent from said vehicle navigation system using said positioning system.

4. The method to control a robotic vehicle according to claim 1, wherein the expected behaviour includes a speed, direction and/or acceleration, and the allowed behaviour includes a range of allowed directions of said vehicle in said subarea.

5. The method to control a robotic vehicle according claim 1, wherein border subareas and inner subareas are defined such that the border subareas do not border neighbouring subareas at all sides, whereas inner subareas borders neighbouring subareas at all sides, and where the allowed behaviour includes a maximum allowed speed being higher at the inner subareas than the border subareas.

6. The method to control a robotic vehicle according to claim 5, wherein border subareas may be fully enclosed by other border subareas such that they can fully enclose obstacles to be excluded from the allowed confined area.

7. The method to control a robotic vehicle according to claim 1, wherein the maximum allowed speed of the vehicle gradually is decreased at the subareas from a highest allowed velocity inner subarea towards the border subareas.

8. The method to control a robotic vehicle according to claim 7, wherein the allowed directions of movement of the vehicle gradually is decreased at the subareas from a highest allowed velocity inner subarea towards the border subareas, such that any direction which would lead the vehicle towards the sides not bordering neighbouring subareas are prohibited.

9. The method to control a robotic vehicle according to claim 1, wherein the allowed behaviour of said vehicle relates to its autonomy in its movement to differ from the directions as set through the vehicle navigation system.

10. The method to control a robotic vehicle according to claim 9, wherein said allowed behaviour is related to subareas where the signal from the position recognition system and/or positioning system s known to be weak or absent, and for these subareas the allowed behaviour includes allowing full steering of the vehicle by the measurements in association with expected and allowed behaviours.

11. The method to control a robotic vehicle according to claim 9, wherein said allowed behaviour is related to unforeseen events affecting the movement of the vehicle and where the allowed behaviour includes departing from the route as set through the vehicle navigation system using positioning system by allowing full steering of the vehicle by the measurements in association with expected and allowed behaviours for a given period.

12. The method to control a robotic vehicle according to claim 1, wherein the expected behaviour for each subarea is compared to the measured actual behaviour when in said subarea, and to initiate a safety procedure if they deviate from each other under some defined rule.

13. A robotic vehicle adapted to operate in a confined area divided into subareas, where it is being steered between the subareas by a vehicle navigation system using a positioning system, where measuring means is positioned on said vehicle for measuring its actual behaviour, wherein each subarea is associated with an expected behaviour related to confirmation that the vehicle is in the expected area according to the steering through the vehicle navigation system and an allowed behaviour limiting an autonomous freedom of said vehicle when in said subarea.

14. A robotic vehicle adapted to operate in a confined area divided into subareas, where it is being steered between the subareas by a vehicle navigation system using a positioning system, where measuring means is positioned on said vehicle for measuring its actual behaviour, wherein each subarea is associated with an expected behaviour related to confirmation that the vehicle is in the expected area according to the steering through the vehicle navigation system and an allowed behaviour limiting an autonomous freedom of said vehicle when in said subarea, said robotic vehicle is adapted to operate according to the method of claim 2.

15. The method to control a robotic vehicle according to claim 2, wherein the expected behaviour includes a speed, direction and/or acceleration, and the allowed behaviour includes a range of allowed directions of said vehicle in said subarea.

16. The method to control a robotic vehicle according to claim 3, wherein the expected behaviour includes a speed, direction and/or acceleration, and the allowed behaviour includes a range of allowed directions of said vehicle in said subarea.

17. The method to control a robotic vehicle according claim 2, wherein border subareas and inner subareas are defined such that the border subareas do not border neighbouring subareas at all sides, whereas inner subareas borders neighbouring subareas at all sides, and where the allowed behaviour includes a maximum allowed speed being higher at the inner subareas than the border subareas.

18. The method to control a robotic vehicle according claim 3, wherein border subareas and inner subareas are defined such that the border subareas do not border neighbouring subareas at all sides, whereas inner subareas borders neighbouring subareas at all sides, and where the allowed behaviour includes a maximum allowed speed being higher at the inner subareas than the border subareas.

19. The method to control a robotic vehicle according claim 4, wherein border subareas and inner subareas are defined such that the border subareas do not border neighbouring subareas at all sides, whereas inner subareas borders neighbouring subareas at all sides, and where the allowed behaviour includes a maximum allowed speed being higher at the inner subareas than the border subareas.

20. The method to control a robotic vehicle according to claim 2, wherein the maximum allowed speed of the vehicle gradually is decreased at the subareas from a highest allowed velocity inner subarea towards the border subareas.
